(19) United States
(12) Patent Application Publication
(10) Pub. No.: US 2003/0085679 A1
(43) Pub. Date: May 8, 2003

(54) Segmented capacitive closure obstruction sensor

(76) Inventors: Anthony G. Bledin, Westlake Village, CA (US); Larry Baxter, Gloucester, MA (US)

Correspondence Address: Colin P. Abrahams, Suite 400, 5850 Canoga Avenue, Woodland Hills, CA, 91367, US

(21) Appl. No.: 10/281,627

(22) Filed: Oct. 28, 2002

Related U.S. Application Data
(60) Provisional application No. 60/345,974, filed on Oct. 28, 2001.
(60) Provisional application No. 60/390,526, filed on Jun. 21, 2002.

(51) Int. Cl. H02P 1/00; H02P 3/00

(52) U.S. Cl. 318/264; 318/280; 49/26

(57) ABSTRACT

The invention is a capacitive sensor system for preventing the pinching or trapping of a human body part or foreign object by a power-closing panel. The body part or object is sensed either before contact or at the time of contact with the sensor electrode by a change in capacitance. When the object or body part is detected, the power closing panels can be reversed or stopped to prevent the trapping of the object. The sensing electrodes consist of multiple segments. Each segment detects the capacitance of the sensed object (with respect to ground or between adjacent or nearby elements) and the adjacent environment. The capacitance values for each of the segments are analyzed in real time and compared against the average of the highest value obtained from a certain number of segments. When the capacitance of one or more segments is less than the average of the capacitance of all or some of the segments minus a predetermined constant, the sensor system is triggered.

### CROSS REFERENCE TO RELATED APPLICATIONS

This application claims the benefit of U.S. Provisional Application No. 60/345,974 filed Oct.28, 2001 and U.S. Provisional Application No. 60/390,526 filed Jun. 21, 2002. Both of these applications are incorporated herein by reference in their entirety.

### FIELD AND BACKGROUND OF THE INVENTION

The following listed below U.S. Patents describe related or background material to that of the present application.

| U.S. Pat. No. | Date | Inventor | |
|---|---|---|---|
| 4,369,344 | January 1983 | Diamond | 200/61.43 |
| 4,452,113 | June 1984 | Pearl | 83/56 |
| 4,785,143 | November 1988 | Miller | 200/61.43 |
| 5,459,962 | October 1995 | Bonne | 49/28 |
| 5,621,290 | April 1997 | Heller | 318/466 |
| 5,754,017 | May 1998 | Tsug | 318/286 |
| 5,802,479 | September 1998 | Kithil | 701/45 |
| 5,912,625 | June 1999 | Scofield | 340/665 |
| 5,932,931 | August 1999 | Tanaka | 307/10.1 |
| 5,933,102 | August 1999 | Miller | 341/33 |
| 5,966,071 | October 1999 | Tsuge | 340/438 |
| 6,032,415 | March 2000 | Tajima | 318/466 |
| 6,114,820 | September 2000 | Nishigaya | 318/466 |
| 6,337,549 | January 2002 | Bledin | 318/466 |
| 6,377,009 | April 2002 | Philipp | 318/468 |

A safety problem associated with powered moving panel closures is that a person, animal, or inanimate object may get in the way of the moving panel. This can obstruct the motion of the panel, but more importantly, can cause severe injury. Of particular interest, in one aspect of the invention, is the operation of electrically powered automobile windows and the provision of an effective means to limit and reverse window travel when a human body part is sensed near the window frame upon closure. However, the invention is not limited to this application and may have application in the use of doors such as automatic opening and closing doors, as well as regular windows.

The number of vehicles equipped with a power-driven window or sunroof is increasing. Such windows or sun roofs utilize the driving force of a motor whereby a light touch to an operating switch permits easy opening and closing of the window or sunroof. However, there exists the danger that foreign matter or a body part may be caught between the upper edge of the window and the window frame in which it is moving upon closing of the window, thus leading to injuries.

National Highway Traffic Safety Administration Standard 118 contains regulations to assure safe operation of power windows.

Several approaches have been made in order to avoid injuries which may result from the situation described above. U.S. Pat. No. 5,459,962 (Bonne) discloses a trapping protector comprising two mutually spaced apart electrical conductors initiating a switching process of a drive unit when brought in contact. U.S. Pat. No. 5,754,017 (Tsug), U.S. Pat. No.5,932,931 (Tanaka) and U.S. Pat. No.5,966,071 (Tsug) teach a power-driven window comprising a load detecting means for detecting the drive load of the motor driving the window. These trapping protectors require physical contact and cause significant squeezing of a body part caught between the upper edge of the window and the window frame. Amended Standard 118 states that the maximum force allowable during closure is to be less than 100 Newton onto a solid cylinder having a diameter of between four and 200 millimeters.

There have been proposed trapping protectors which do not require physical contact and, accordingly, do not cause squeezing. U.S. Pat. Nos. 4,453,112 and 5,621,290 (Heller), the disclosures of which are incorporated herein by reference, teach capacitive sensors. Arranged on a window frame is at least one sensor electrode to which an alternating current is applied. As soon as an electrically conductive medium such as a human body part is near the sensor electrode, the capacity between the sensor electrode and a ground electrode changes. The change in capacity changes the frequency of an output signal of the sensor electrode. This change is compared to a reference level, and the motor for the window is stopped or reversed if the change exceeds the threshold. The capacitive sensors can only detect dielectric materials. Wood, plastic or any other non-conductive material cannot be detected as they do not cause a change of capacity.

Another patent has described a single capacitive sensor probe adjacent to the orifice of the closing aperture. In U.S. Pat. No. 6,377,009 (Philipp), describes a way to prevent trapping of human body parts in closing power panels. However, in this patent, the probe cannot differentiate between the closing panel and a trapped object unless (a) the sensor probe only detects an object adjacent to the power-closing panel and not directly in the path of the power-closing panel or (b) the exact position of the closing panel is known and the expected capacitance at the position is known. If the capacitance is less than the expected value for that particular position the sensors is trigger and appropriate action is taken.

U.S. Pat. No. 6,337,549 (Bledin) teaches that a body part can be detected in the path of a power-closing panel by capacitance. This patent also teaches that an object that has a low dielectric value or a small mass that cannot be detected by capacitance can be detected in the power closing panels by displacement or movement of the sensor probe by a “soft spot”. The current invention may also use this concept to detect objects of small mass and small dielectric value.

U.S. Pat. No. 5,933,102 (Miller) teaches the a body part can be detected by capacitance by multiple sensor elements, but does not compare values obtained. It averages these value and determines if any one value exceeds a threshold thereby differentiating the closing power panel from the trapped object.

U.S. Pat. No. 5,802,479 (Kithil) consists of a roof-mounted passenger position sensor array of capacitive coupling passenger position sensors, to determine position and motion of a passenger by analysis of distances of the passenger to the various sensors of the array and analysis of the changes of said distances with time. This patent used a sensor array for detecting the x, y and z coordinates of the position of a person. This is considerably different in principle to the present invention, which compares all, or some, of the values obtained, averages these values and determines if any one value exceed a

### SUMMARY OF THE INVENTION

According to one aspect of the invention, there is provided a detection device for detecting the presence of an object in or adjacent a space defined by a frame in which a panel is moved by a motor between a first position to at least partially open the space and a second position to substantially close the space, the detection device comprising: a first sensor plate having a plurality of segment sensors; a second sensor plate having a plurality of segment sensors, the first and second sensor plates being disposed with respect to each other so that capacitance is formed therebetween; a monitor for assessing the capacitance between the first sensor plate and the second sensor plate, the monitor being configured so as to detect a change in the capacitance produced by an object in the space; and activating means for operating the motor when a change in capacitance has been detected. An aspect of the invention is to prevent the pinching or trapping of a human body part or foreign object in a power-closing panel. In general, one particular form of the invention achieves this goal by capacitively sensing a human body part and differentiating the power-closing panel from a trapped object.

The sensor of the invention may be comprised of a multi-segment sensor probe oriented adjacent to the aperture of the orifice of the power closing panels. The electronics of the multi-segment sensor measures the capacitance of each segment, and/or the capacitance between adjacent segments.

As the panel closes, the individual capacitance values are obtained along the length of the sensor probe. If no obstruction is present at or within the aperture, the values between each of the segments (or the capacitance to ground of the individual sensor elements) of the sensor probe are equal.

If an object is trapped in the path of the power closing panel, the value obtained between each of the segments of the probe (or the capacitance to ground of the individual sensor elements) will be non-uniform and thus trigger an action which can be taken to prevent the power panel from closing. Such action might be to stop the panel and/or reverse its direction.

### BRIEF DESCRIPTION OF THE DRAWINGS

FIG. 1 is a single panel power closure aperture with segment sensor probes adjacent to closing aperture;

FIG. 2 is a double panel power closure aperture with segment sensor probes on the closing panels and with no trapped object in the aperture and equal capacitance between segmented sensor probes; and

FIG. 3 is a double panel power closure aperture with segment sensor probes on the closing panels as shown in FIG. 2 and showing body parts or objects trapped in closing panels, with unequal capacitance between segment sensor probes

### DETAILED DESCRIPTION OF THE INVENTION

An aspect of the invention is to prevent the pinching or trapping of a human body part or foreign object in a power-closing panel such as a window, door, sunroof, hood or trunk lid, or other closure part. The power-closing panels are found in the automotive industry such as cars, vans, trains, buses, trucks, or other conveyance. Power closing doors, particularly in inclement climates (either hot or cold), are commonly found in buildings that rapidly open and close doors to allow vehicles or persons to pass into enclosed areas.

In general, the invention addresses this goal by capacitively sensing a human body part or other object, either before contact with a sensing electrode or plate, or at the time of contact with the plate. The sensor has the ability to differentiate the power-closing panel from a trapped object or object located in the aperture. The sensing electrode may be a metal strip or wire embedded in a plastic or rubber molding strip, placed behind a piece of fascia or other trim part, or simply a metal element on top of the trim parts. Sensing electrodes of this sort can, be prepared from conductive ink, adhesive-backed metal foil, metal mesh strips, or simply wires or serpentine-laid wire.

The sensor may be comprised of a multi-segment sensor probe oriented adjacent to the aperture of the orifice of the power closing panels. The electronics of the multi-segment sensor measures the capacitance of each segment, or the capacitance between adjacent segments. As the panel closes, the individual capacitance values along the length of the sensor probe are measured and monitored. If no obstruction is present at or within the aperture, the values between each of the segments (or the capacitance to ground of the individual sensor elements) of the sensor probe are equal. If an object is trapped or located in the path of the power closing panel, the value obtained between each of the segments of the probe (or the capacitance to ground of the individual sensor elements) will be non-uniform and thus action can be taken to prevent the power panel from closing. Such actions might be to stop the panel and reverse its direction.

Another aspect of the invention is to place the sensor probe in close proximity to the aperture of the power-closing panel, eliminate non-sensed area adjacent to the sensor probe.

Multiple types of capacitive sensing technology may be employed in the present invention.

Yet, another aspect of the invention is to provide a capacitive sensor for a panel closure control system that is not affected by either rapidly or slowly changing environmental conditions. As the segmented sensor of the current invention compares values obtained between segments of the sensor, environmental changes are expected to be uniform along the sensor probe. Thus changing environmental conditions will not affect the functions of the sensor.

Reference is now made to the accompanying drawings.

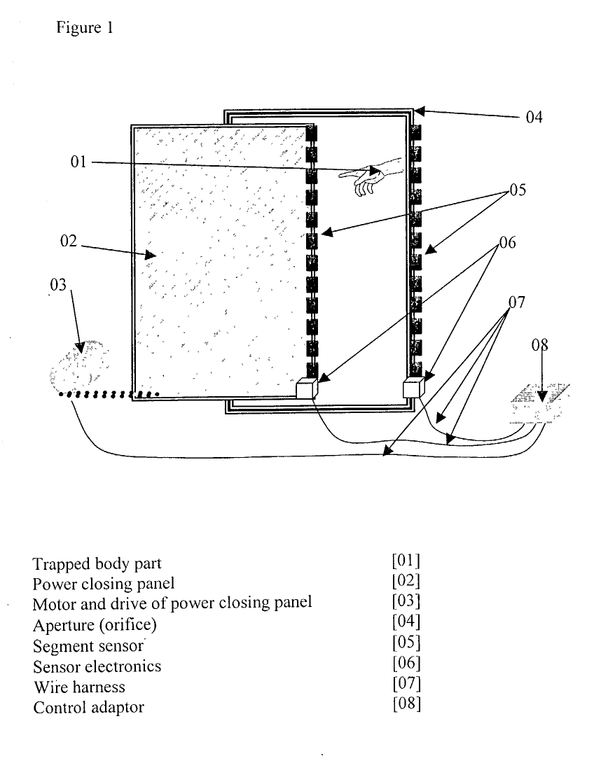

The sensor system of the invention is generally comprised of a segment sensor array [05], its sensor electronics [06], and a control adaptor [08]. (See FIGS. 1, 2 and 3.)

Two or more plates comprise the segment sensor array. The plates can be of equal or unequal size. The plates may be metal strips or wires, which can be embedded in a plastic or rubber molding strip, placed behind a piece of fascia or other trim part, or simply be metal elements on top of the trim parts. Sensing electrodes of this sort can be prepared from conductive ink, made of adhesive backed metal foil, formed from a metal mesh strip, or simply be a wire or serpentine-laid wire. The size and shape of the sensor elements is dependent on the properties and characteristics of the aperture and power closing panels as well as the environment in which the device is expected to operate. The size and shape can be adjusted to increase or decrease the sensitivity and range of the detected object.

The sensor elements can be placed on compressible substances so that displacement of the sensor elements by objects that have low capacitance change the sensor position, changing its capacitances.

In FIG. 1 of the drawings, it will be seen that the sensor electronics [05] drive the capacitive plates and are capable of determining an analog or digital voltage value for the capacitance of each of the plate relative to each other or relative to ground. The capacitance between two adjacent plates or between a single plate and ground will decrease as an object of high dielectric number (or one that is grounded) approaches the plate. The control adaptor [08] continuously analyzes and monitors the value obtained from the sensor electronics. As the closing panel [02] traverses and closes the aperture [04], each of the capacitances between adjacent capacitor plates decreases equally when no object is located or trapped in the aperture of the power-closing panel. If an object (e.g. body part) [01] is located or trapped in the aperture of the closing panel, there will be unequal values of capacitance between adjacent plates and the control adaptor [08] will stop or reverse the motor [03] of the power-closing panel, preventing trapping of an object. The power-closing panel [02] may be a window, door, sunroof, hood or trunk lid, or other closure part of an automobile. The power-closing panel may also be the door of a building or warehouse.

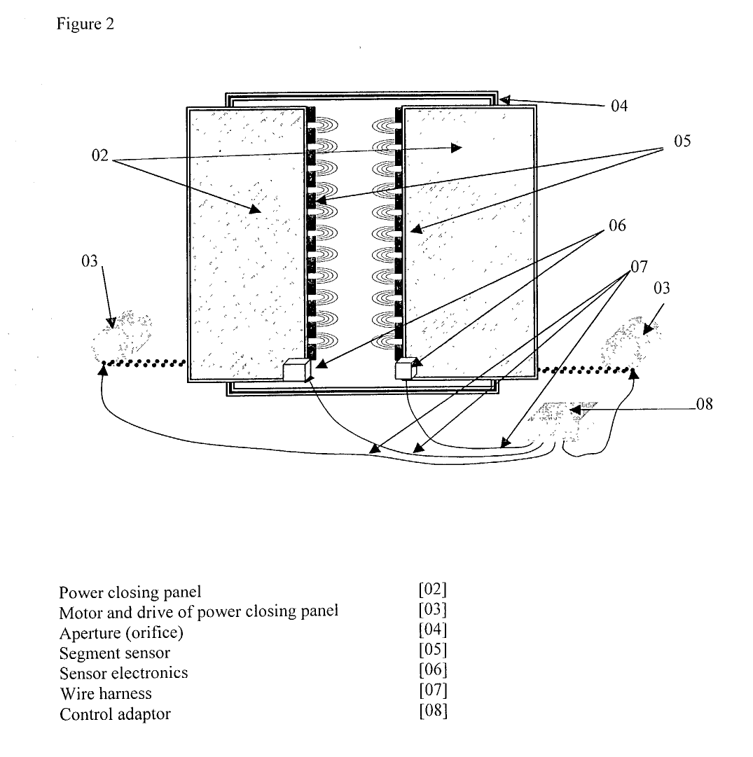

FIG. 2 of the drawings represents the sensor system protecting the leading edge of two power closing panels [02] closing an aperture. Each of the power-closing panel represents a train door. At the leading edge of each door is a sensor array consisting of 12 capacitive plates for each door measuring capacitance between each of the plates. The capacitance is equal between each of the plates when there is no object trapped or located between the closing power panels (train doors). When a certain number of plates are less than a predetermined threshold, the control adaptor deems the doors to be shut.

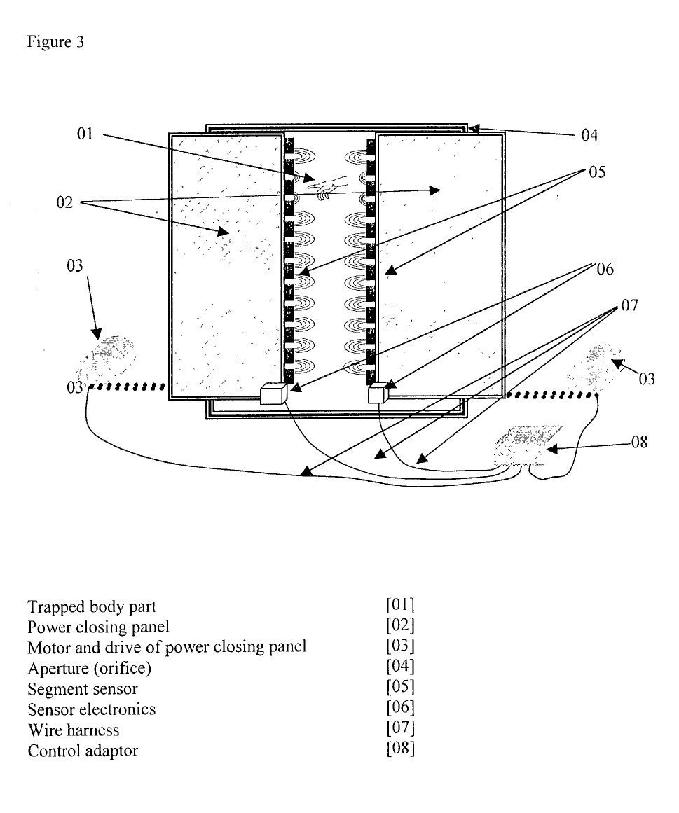

FIG. 3 represents a sensor system protecting the leading edge of two power closing panels closing an aperture. Each of the power-closing panel represents a train door. At the leading edge of each door is a sensor array consisting of 12 capacitive plates for each door measuring capacitance between each of the plates. The capacitance is unequal between the plates and therefore there is an object trapped or located between the closing power panels (train doors). In the example in FIG. 3, the capacitance is equal between plates 1 and 2 and plates 4 through 12 and is not equal to the capacitance between plates 2 and 3 and 3 and 4. In this example, an average of the lowest 10 capacitances, corrected by a constant, sets the trigger value. If any one capacitance value is less than this trigger value, the device triggers. Multiple algorithms can establish when to trigger the device dependent on the sensitivity required.

1. A control system responsive to an obstruction of a motorized closing panel which is closing an aperture, the system comprising;
a controller adaptor to control the motor, which when actuated reverses or stops the motorized closing panels,
two or more sensor plates located adjacent to a portion of the aperture or on the closing panels assessing capacitance between the plates and/or to ground, and
an electronic device or micro controller capable of measuring and analyzing the capacitances of the sensor plates and determining when any one or more of the capacitance values is less that the average of the highest value obtained for a certain number of plates minus a predetermined threshold value, and when this conditions is met it actuates the control adaptor.

2. A control system as claimed in claim 1 wherein sensing electrodes of the sensor plates of the control system comprises metal strips or wires, which can be embedded in a plastic or rubber molding strip, placed behind a piece of fascia or other trim part.

3. A control system as claimed in claim 1 wherein sensing electrodes of the sensor plates of the control system comprise one or more of the following: a metal strips or wires which can be embedded in a plastic or rubber molding strip, placed behind a piece of fascia or other trim part; a metal element(s) on top of trim parts and the sensing electrodes are prepared from conductive ink, made of adhesive backed metal foil formed from a metal mesh strip, or simply be a wire or serpentine-laid wire, said sensor plates of the control system being shaped as one of circular, oval, square, rectangular, triangular, and polygonal of greater than four sides and may be unequal or equal in size.

4. A control system as claimed in claim 1 wherein a single oscillator drives all the capacitive-coupling sensors.

5. A control system as claimed in claim 1 wherein the sensor plates measure capacitance to ground or may measure capacitance between any one plate and any other plate or any combination of these values.

6. A control system as claimed in claim 1 capable of analyzing the data and determining when the panel has closed the aperture when a predetermined number of sensor plates capacitance average is less the predefined threshold.

7. A control system as claimed in claim 1 which when actuated may in turn actuate a visual or auditory warning, a mechanical action or an electrical action.

8. A control system as claimed in claim 1 wherein some or all of the sensor plates are placed on a compressible or movable substrate whereby movement of the plates would change the capacitance.

9. A detection device for detecting the presence of an object in or adjacent a space defined by a frame in which a panel is moved by a motor between a first position to at least partially open the space and a second position to substantially close the space, the detection device comprising:
a first sensor plate having a plurality of segment sensors;
a second sensor plate having a plurality of segment sensors, the first and second sensor plates being disposed with respect to each other so that capacitance is formed therebetween;
a monitor for assessing the capacitance between the first sensor plate and the second sensor plate, the monitor being configured so as to detect a change in the capacitance produced by an object in the space; and
activating means for operating the motor when a change in capacitance has been detected.

10. A detection device as claimed in claim 9 wherein the first sensor plate is mounted on the frame and the second sensor plate is mounted on the panel.

11. A detection device as claimed in claim 9 wherein the first and second sensor plates are mounted on different parts of the frame.

12. A detection device as claimed in claim 9 wherein the first sensor plate and the second sensor plate each have at least four segment sensors, the segment sensors of the first sensor plate being aligned with the segment sensors of the second sensor plate.

13. A detection device as claimed in claim 12 wherein the first sensor plate and the second sensor plate each have twelve segment sensors.

14. A detection device as claimed in claim 9 wherein the monitor assesses capacitance between a pair of segment sensors formed by an individual segment sensor on each of the first and second sensor plates respectively so as to determine when the capacitance between one or more pairs of segment sensors is less than the average of the highest value obtained for a selected number of pairs of segment sensors minus a predetermined threshold value, and activates the motor when this condition is met.

15. A detection device as claimed in claim 9 wherein the sensor plates are selected from one or more of the group consisting of: a metal strip, a metal wire, conductive ink, adhesive backed metal foil, a metal mesh strip, and a wire or serpentine-laid wire.

16. A detection device as claimed in claim 15 wherein the sensor plates have a shape which is selected from one or more of the group consisting of: circular, oval, square, rectangular, triangular, polygonal having more than four sides each of which may be the same as or different in length to other sides.

17. A detection device as claimed in claim 9 wherein the monitor is capable of analyzing data from the sensor plates and determining when the panel has closed the space when a predetermined number of sensor plates' capacitance average is less a predefined threshold.

18. A detection device as claimed in claim 9 further comprising a visual or auditory warning, a mechanical action or an electrical action when a change in capacitance has been detected.

19. A detection device as claimed in claim 9 wherein at least one sensor plates is mounted on a compressible or movable substrate so that movement of the sensor plate changes the capacitance.
